(19) United States
(12) Patent Application Publication
(10) Pub. No.: US 2004/0239767 A1
(43) Pub. Date: Dec. 2, 2004

(54) Systems and methods for providing tactile feedback

(76) Inventors: Donald J. Stavely, Windsor, CO (US); Wilfred F. Brake, Ft. Collins, CO (US); Dan L. Dalton, Greeley, CO (US); James C. Dow, Ft. Collins, CO (US); Amy E. Battles, Windsor, CO (US)

Correspondence Address: HEWLETT-PACKARD COMPANY, Intellectual Property Administration, P.O. Box 272400, Fort Collins, CO, 80527-2400, US

(21) Appl. No.: 10/447,833

(22) Filed: May 29, 2003

(51) Int. Cl. H04N 5/225

(52) U.S. Cl. 348/207.99

(57) ABSTRACT

Disclosed are systems and methods for providing tactile feedback as to device operation. In one embodiment, a system and method pertain to determining whether a device function for which tactile feedback is to be provided is implicated, and, if so, actuating a mechanical actuator of the device to create tactile feedback that indicates to the user that the function is being or has been performed.

### BACKGROUND

Several portable and/or handheld devices automatically provide tactile feedback as to device operation as a consequence of actuation of the internal mechanisms that are used to perform device functions. One example of a device that provides such feedback is the single-lens reflex (SLR) camera. When an image is captured with such a camera, the user typically feels the shutter of the camera snap, thereby indicating that the image has been captured. Furthermore, after the image is captured, the user normally feels vibrations associated with the operation of an internal motor that advances the film to the next unexposed portion of film. Such vibrations provide further tactile feedback as to the operation of the camera and the state in which it is in.

Due to the advancements achieved through use of digital technologies, little or no such tactile feedback is provided to users. For example, in the case of a digital camera, the shutter is typically so small that the user simply cannot detect its actuation. This is in contrast to SLR film cameras that use a large focal plane shutters, which provide very definite user feedback. Furthermore, in that such cameras do not use film, there is no feedback provided from operation of a film advancement motor.

Absence of the tactile feedback that users are accustomed to experiencing creates a perceived disconnect between the user and the device. Specifically, lost is one mode of communicating to the user how the device is operating and the state in which it is in. Therefore, the user may need to take some affirmative action to confirm that the device function that the user intended to be performed was actually performed. For instance, in the case of a digital camera, the user may need to check a camera display after the shutter-release button was pressed to confirm that an image was actually captured.

In view of the disadvantage created by loss of tactile feedback, some device manufacturers have configured their devices to provide other types of feedback to the user. To cite one example, several digital camera manufacturers produce digital cameras that emit an audible “click” noise when an image is captured to emulate the sound made by actuation of a film camera shutter. Although such audible feedback is useful in some situations, it is undesirable or of little use in others. For instance, in some situations (e.g., when capturing an image inside a normally quiet place like a church or temple), the user may not wish for sounds to be emitted by the device so as not to disturb others. In other situations, the user may not be concerned about creating noise, but may not be able to hear the sound emitted by the device due to noise within the environment in which the device is used.

Accordingly, it would be desirable to provide tactile feedback to device users for performance of certain implicated device functions.

### SUMMARY

Disclosed are systems and methods for providing tactile feedback as to device operation. In one embodiment, a system and method pertain to determining whether a device function for which tactile feedback is to be provided is implicated, and, if so, actuating a mechanical actuator of the device to create tactile feedback that indicates to the user that the function is being or has been performed.

### BRIEF DESCRIPTION OF THE DRAWINGS

The disclosed systems and methods can be better understood with reference to the following drawings. The components in the drawings are not necessarily to scale.

FIG. 1 is a block diagram of an embodiment of a device that provides tactile feedback.

FIG. 2 is a flow diagram illustrating an embodiment of a method for providing tactile feedback to a user.

FIG. 3 depicts a device in providing tactile feedback.

FIG. 4 is a flow diagram illustrating an embodiment of operation of a tactile feedback control of the device shown in FIG. 1.

### DETAILED DESCRIPTION

As identified in the foregoing, tactile feedback is often not provided for operation of modern portable and/or handheld devices such as digital cameras. This is unfortunate in that such tactile feedback provides the user with useful information as to device operation and/or state. As is discussed in the present disclosure, however, such tactile feedback can be provided to the device user by actuating an existing mechanical actuator of the device when a given device function is implicated. In such a case, tactile feedback is provided to the user without the need for, and the associated expense of, an additional device component. In some cases, the mechanical actuator is actuated in a manner such that the tactile feedback provided emulates the feedback normally provided to the user with a non-digital analogue (e.g., film camera).

Disclosed herein are embodiments of systems and methods for providing tactile feedback. Although particular embodiments are disclosed, these embodiments are provided for purposes of example only to facilitate description of the disclosed systems and methods. Accordingly, other embodiments are possible.

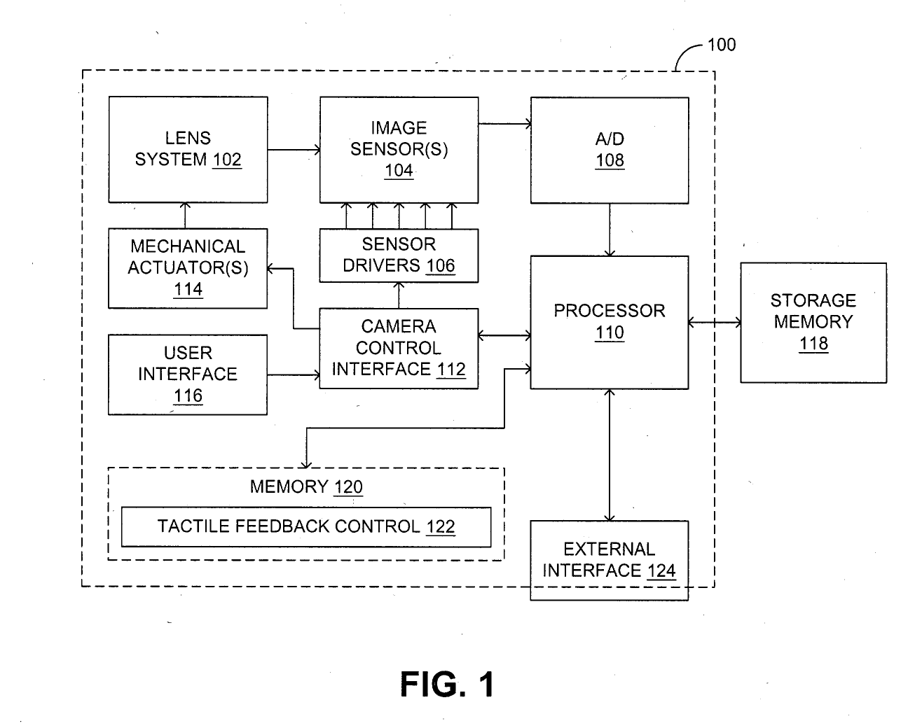

Referring now to the drawings, in which like numerals indicate corresponding parts throughout the several views, FIG. 1 illustrates an embodiment of a device that is configured to provide tactile feedback. In the example of FIG. 1, the device 100 is configured as a digital camera. Although a digital camera is illustrated in FIG. 1 and explicitly discussed herein, the device 100 more generally comprises any portable and/or handheld device for, which tactile feedback is useful. Therefore, in other embodiments, the device can, for example, comprise a personal digital assistant (PDA), mobile telephone, or the like.

As indicated FIG. 1, the camera includes a lens system 102 that conveys images of viewed scenes to one or more image sensors 104. The lens system 102 comprises one or more lenses, as well as other components that control or modify the collection of light for the purposes of capturing images. Such components include, for example, a shutter and an aperture wheel. By way of example, the image sensors 104 comprise charge-coupled devices (CCDs) that are driven by one or more sensor drivers 106, or complimentary metal oxide semiconductor (CMOS) sensors. The analog image signals captured by the sensors 104 are then provided to an analog-to-digital (A/D) converter 108 for conversion into binary code that can be processed by a processor 110.

Operation of the sensor drivers 106 is controlled through a camera control interface 112 that is in bi-directional communication with the processor 110. Also controlled through the interface 112 are one or more mechanical actuators 114 that are used to control operation of the lens system 102. These actuators 114 include, for instance, the actuator used to manipulate the camera shutter, the motor used to rotate the aperture wheel, the focus motor, and the zoom motor. Operation of the camera control interface 112 may be adjusted through manipulation of a user interface 116. The user interface 116 comprises the various components used to enter selections and commands into the camera 100 such as a shutter-release button and various control buttons provided on the camera.

Captured digital images may be stored in storage memory 118, such as that contained within a removable solid-state memory card (e.g., Flash memory card). In addition to this memory, the camera comprises permanent (i.e., non-volatile) memory 120. In some embodiments, the memory 120 includes a tactile feedback control 122, which comprises a program and/or algorithm used to control actuation of one or more mechanical actuators (e.g., motors 114) to provide tactile feedback to a user. Although this tactile feedback control is illustrated as being contained within device memory 120, such control can, alternatively, be integrated into the processor 110 and/or control interface 112, if desired.

In addition to the aforementioned components, the camera 100 comprises an external interface 124 through which data (e.g., images) may be transmitted to another device, such as a desktop personal computer (PC). By way of example, this interface 124 comprises a universal serial bus (USB) connector.

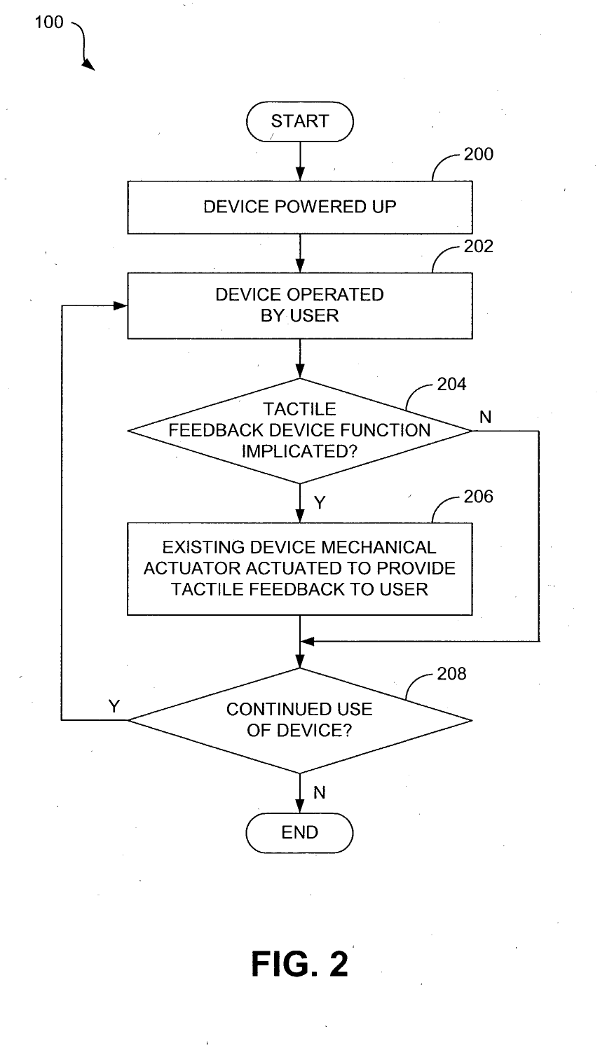

FIG. 2 illustrates an embodiment of a method for providing tactile feedback. In particular, FIG. 2 is a flow diagram that provides an overview of a method for providing tactile feedback to a user in relation to certain implicated device functions so as to physically communicate to the user that those functions have been or are being performed by the device. It is noted that any process steps or blocks described in the flow diagrams of this disclosure may represent modules, segments, or portions of program code that includes one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

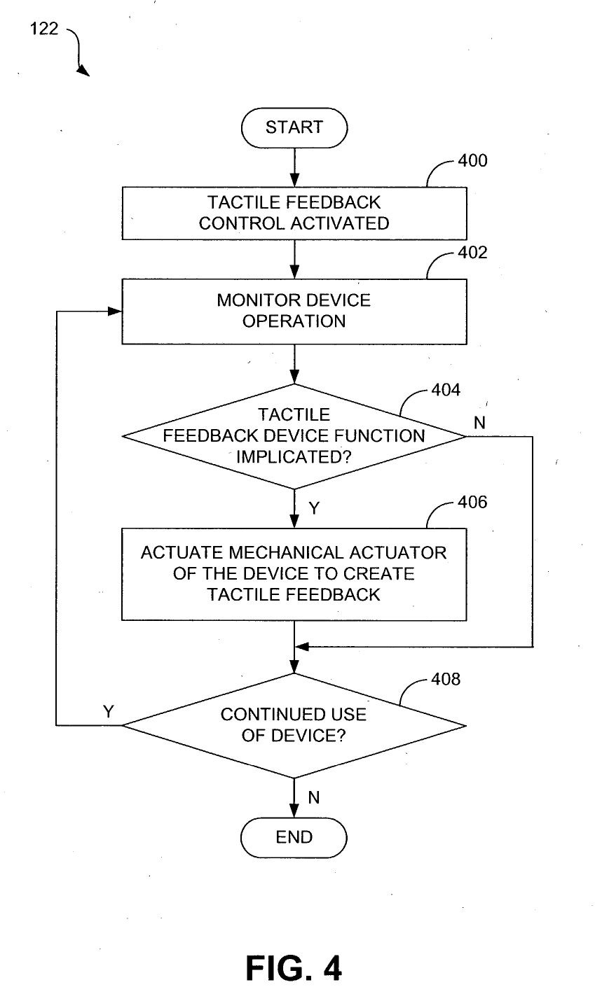

Beginning with block 200, the device is powered up. As described in the foregoing, the device comprises any portable and/or handheld device. Once the device is powered, the device is operated by the user, as indicated in block 202. The nature of such operation depends upon the nature of the device. If the device comprises, for example, a digital camera, such operation may include device functions associated with image capture (e.g., manipulation of the lens system) or image review (e.g., displaying captured images). With reference next to decision block 204, it is determined whether a tactile feedback device function is implicated. In particular, it is determined whether a device function for which tactile feedback is to be provided is about to be, is being, or has been performed. The nature of such device functions depends on the nature of the device. Specific examples are described in detail in relation to FIG. 4.

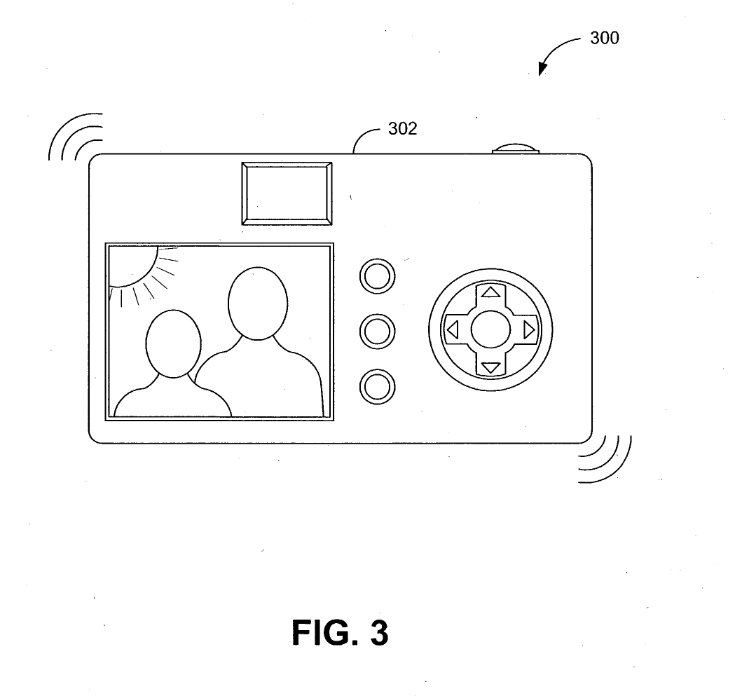

If a tactile feedback device function is not implicated, flow continues down to decision block 208 described below. However, if a tactile feedback device function is implicated, flow continues to block 206 and an existing device mechanical actuator is actuated to create tactile feedback for the user. Specific examples of the types of actuation performed, and therefore the type of tactile feedback provided, are discussed in detail in relation to FIG. 4. Generally speaking, however, physical feedback is provided to the user that indicates to the user that a given device function is being or has been performed. Such feedback normally comprises vibrations generated by actuation of the mechanical actuator or actuators that are transmitted to the user's hand or hands through the device housing. FIG. 3 depicts such vibrations being transmitted to the exterior housing 302 of an example device 300 and, more particularly, a digital camera. As shown in this figure, the vibrations cause the device 300 itself to vibrate. The vibrations may be very short in duration or relatively long in duration depending upon the type of feedback that is desired.

In some cases, the tactile feedback emulates feedback typically provided by other devices. For instance, if the device is a digital camera, the tactile feedback may emulate that typically provided when a similar function is performed by a film camera. In any case, in situations in which the actuator is an already-existing mechanical actuator that has a primary purpose other than providing tactile feedback, tactile feedback is provided without the need for a separate, dedicated actuator, thereby saving device space and reducing device expense.

Next, with reference to decision block 208, it is determined whether there is to be continued use of the device. If not, the device presumably is to be powered down, and flow for the session is terminated. If, on the other hand, the device will continue to be used, flow returns to block 202 and continues in the manner described above.

FIG. 4 illustrates operation of the tactile feedback control 122 shown in FIG. 1. Beginning with block 400, the tactile feedback control 122 is activated. This activation may occur in response to device power up. Alternatively, however, activation of the tactile feedback control 122 can occur when a given operating mode in which implicated device functions (i.e., those for which to provide tactile feedback) can be performed. Irrespective of the manner in which the tactile feedback control 122 is activated, device operation is monitored, as indicated in block 402. Specifically, device operation is monitored to determine whether a tactile feedback device function is implicated. As described above in relation to FIG. 2, this comprises monitoring device operation to determine whether a device function for which tactile feedback is to be provided is about to, is being, or has been performed, depending on the type of tactile feedback to be provided.

Again, the nature of the device functions for which tactile feedback is to be provided depends, at least in part, on the nature of the device. For purposes of discussion, the device is assumed to be a digital camera. In such a case, the device function may comprise, for instance, capturing of an image and, more particularly, actuation of the camera shutter. To cite another example, the device function may comprise advancing of images that are being displayed in the camera back panel display. With reference to block 404, if a tactile feedback device function is not implicated, flow returns to block 402 at which monitoring continues. If, on the other hand, a tactile feedback device function is implicated, flow continues to block 406 and a mechanical actuator of the device is actuated to create tactile feedback. The type of actuator that is actuated depends upon, at least in part, the type of device. Again, assuming the device is a digital camera, the actuation may comprise actuation of one or more of the actuator used to manipulate the camera shutter, the motor used to rotate the aperture wheel, the focus motor, and the zoom motor. Which of these actuators is actuated may also depend upon the nature of the particular device (e.g., camera). Specifically, the actuator must be substantial enough such that its actuation creates vibrations that are strong enough for the typical user to feel. Therefore, in the case of a digital camera, most suitable may be the focus and/or zoom motors.

The nature of the actuation of the selected mechanical actuator may depend upon the device function for which tactile feedback is to be provided. Once again, assuming a digital camera, a short duration (e.g., a tenth of a second) of actuation may be used when an image is captured to emulate the vibrations created by actuation of a film camera shutter. However, a relatively long duration (e.g., one second) of actuation may be used after the image is captured to emulate advancement of film in a film camera. These types of tactile feedback provide confirmation to the user as to the performance of camera functions, and further provides an indication as to the state (e.g., ready to capture another image) of the camera.

Tactile feedback may further be used during image review. For instance, each time the user scrolls to the next of a series of captured images using the user interface, the mechanical actuator may be actuated to again emulate advancement of film.

In any of the examples described above, the mechanical actuator preferably is actuated in a manner such that the initial configuration of the actuator, as well as the components it affects, is reacquired after the actuation has been completed. For instance, if the focus motor of a digital camera was actuated to emulate manipulation of the shutter, the motor may be driven in a first direction from an initial focus setting, and then in the opposite direction an equal amount so that the initial focus setting is reacquired. With this form of operation, device operation is not interfered with as a consequence of tactile feedback being provided.

Next, with reference to decision block 408, it is determined whether there is to be continued use of the device. If not, the device presumably is to be powered down, and flow for the session is terminated. If, on the other hand, the device will continue to be used, flow returns to block 402 at which monitoring, and the provision of tactile feedback, continues.

What is claimed is:

1. A method for providing tactile feedback to a device user, comprising:
determining whether a device function for which tactile feedback is to be provided is implicated; and
if so, actuating a mechanical actuator of the device to create tactile feedback that indicates to the user that the function is being or has been performed.

2. The method of claim 1, wherein determining whether a device function for which tactile feedback is implicated comprises determining whether a device function for which tactile feedback is to be provided is about to be, is being, or has been performed.

3. The method of claim 1, wherein determining whether a device function for which tactile feedback is to be provided comprises determining if an image is about to be or is being captured.

4. The method of claim 1, wherein determining whether a device function for which tactile feedback is to be provided comprises determining if an image has just been captured.

5. The method of claim 1, wherein determining whether a device function for which tactile feedback is to be provided comprises determining if an image of a series of images is being scrolled to.

6. The method of claim 1, wherein actuating a mechanical actuator comprises actuating an already-existing actuator of the device, the actuator having a primary purpose other than providing tactile feedback.

7. The method of claim 1, wherein actuating a mechanical actuator comprises actuating a shutter actuator.

8. The method of claim 1, wherein actuating a mechanical actuator comprises actuating an aperture motor.

9. The method of claim 1, wherein actuating a mechanical actuator comprises actuating a focus motor.

10. The method of claim 1, wherein actuating a mechanical actuator comprises actuating a zoom motor.

11. The method of claim 1, wherein actuating a mechanical actuator to create tactile feedback comprises actuating a mechanical actuator to generate vibrations that are transmitted to a device housing.

12. The method of claim 1, wherein actuating a mechanical actuator to create tactile feedback comprises actuating a mechanical actuator in an manner that emulates tactile feedback provided when a similar function is performed by a different type of device.

13. The method of claim 1, further comprising, prior to determining whether a device function is implicated, monitoring device operation.

14. A system for providing tactile feedback, comprising:
a mechanical actuator; and
a tactile feedback control that is configured to actuate the mechanical actuator in association with a given device function that does not require such actuation of the mechanical actuator.

15. The system of claim 14, wherein the mechanical actuator comprises a shutter actuator.

16. The system of claim 14, wherein the mechanical actuator comprises an aperture motor.

17. The system of claim 14, wherein the mechanical actuator comprises a focus motor.

18. The system of claim 14, wherein the mechanical actuator comprises a zoom motor.

19. The system of claim 14, wherein the tactile feedback control is adapted to be stored in a device memory.

20. The system of claim 14, wherein the tactile feedback control is configured to actuate the mechanical actuator in association with capture of an image.

21. The system of claim 14, wherein the tactile feedback control is configured to actuate the mechanical actuator in association with scrolling to a next image in a series of images.

22. A system for providing tactile feedback, comprising:
means for determining whether a device function for which tactile feedback is to be provided is implicated; and
means for generating tactile feedback in association with the device function that indicates to a user that the device function is being or has been performed.

23. The system of claim 22, wherein the means for determining comprise a tactile feedback control.

24. The system of claim 22, wherein the means for generating tactile feedback comprise means for creating vibrations that are transmitted to a device housing.

25. The system of claim 22, wherein the means for generating tactile feedback comprise at least one of a shutter actuator, an aperture motor, a focus motor, and a zoom motor.

26. The system of claim 22, wherein the means for generating tactile feedback comprise means for actuating a mechanical actuator in an manner that emulates tactile feedback provided when a similar function is performed by a different type of device.

27. A digital camera, comprising:
a mechanical actuator; and
a tactile feedback control that is configured to actuate the mechanical actuator when given camera functions are performed so as to provide tactile feedback as to the performance of the given camera functions.

28. The camera of claim 27, wherein the mechanical actuator comprises at least one of a shutter actuator, an aperture motor, a focus motor, and a zoom motor.
